(19) United States
(12) Patent Application Publication
(10) Pub. No.: US 2007/0048019 A1
(43) Pub. Date: Mar. 1, 2007

(54) Coupling structure usable with image forming apparatus

(75) Inventors: Hyung-jin Kim, Seoul (KR); Sung-gi Kim, Seoul (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/485,367

(22) Filed: Jul. 13, 2006

(30) Foreign Application Priority Data
Aug. 23, 2005 (KR) 10-2005-0077535

(51) Int. Cl. G03G 15/06

(52) U.S. Cl. 399/222

(57) ABSTRACT

A coupling structure usable with an image forming apparatus which includes a hopper frame to accommodate toner and an agitator, a development frame coupled to the hopper frame and installed with a developing roller and a supply roller to supply the toner to the developing roller, a plurality of gears to rotate and drive each of the agitator, the developing roller, and the supply roller, a first coupling protrusion to protrude from an outer surface of the development frame, and a development cap member coupled to the outer surface of the development frame and having first and second bushings to rotatably support the developing roller and the supply roller and a coupling portion into which the first coupling protrusion is inserted.

### CROSS-REFERENCE TO RELATED APPLICATIONS

This application claims the benefit of Korean Patent Application No. 10-2005-0077535, filed on Aug. 23, 2005, in the Korean Intellectual Property Office, the disclosure of which is incorporated herein in its entirety by reference.

### BACKGROUND OF THE INVENTION

1. Field of the Invention

The present general inventive concept relates to a coupling structure usable with an image forming apparatus, and more particularly, to a coupling structure usable with an image forming apparatus which can restrict vibration of a rotary body during an operation of a developing unit and simultaneously facilitate coupling between a plurality of gears and constituent parts thereof.

2. Description of the Related Art

In general, electrophotographic image forming apparatuses, such as laser printers, facsimiles, and digital copiers, print an image by scanning light onto a photosensitive medium charged with a predetermined electric potential to form an electrostatic latent image, developing the electrostatic latent image with toner of a predetermined color, and transferring and fusing the developed image onto a sheet of paper.

FIG. 1 is a cross-sectional view of a conventional electrophotographic image forming apparatus. Referring to FIG. 1, an electrophotographic image forming apparatus includes a cabinet 10, and a charger 11, a photosensitive drum 13, a light scanning unit 15, a developing unit 20, a transfer roller 17, and a fusing roller 19 which are provided in the cabinet 10.

The photosensitive drum 13 is charged with a predetermined electric potential by the charger 11. As the light scanning unit 15 scans a light beam L onto the photosensitive drum 13, an electrostatic latent image corresponding to an image to be printed is formed on an outer circumferential surface of the photosensitive drum 13. The developing unit 20 accommodates toner T. The toner T is supplied to the photosensitive drum 13 by means of an agitator 27, a supply roller 29, and a developing roller 21. Thus, a toner image is formed on the surface of the photosensitive drum 13 corresponding to the electrostatic latent image. The toner image on the photosensitive drum 13 is transferred to a print paper S supplied between the photosensitive drum 13 and the transfer roller 17 and fused on the print paper S by the fusing roller 19.

The developing unit 20 is an integral cartridge including a container 25 where the photosensitive drum 13 and the toner T are accommodated. The developing unit 20 is replaced when the toner T accommodated in the container 25 is used up.

The image forming apparatus prints an image on the print paper S that is supplied from first and second paper feed cassettes 31 and 35 and includes a paper feed path 41 and a paper output path 45. Pickup rollers 32 and 36 for picking up the print paper S one by one, a feed roller 33 for guiding supply of the picked up print paper S, and a registration roller 42 for developing an image at a desired position on the supplied print paper S are arranged along the paper feed path 41. The fusing roller 19 and a plurality of paper output rollers 47 are provided along the paper output path 45. Thus, the printed paper S is output through the paper output path 45 and stacked on a stacking portion 50 provided in an upper portion of the cabinet 10.

In the conventional electrophotographic image forming apparatus configured as above according to the present invention, the photosensitive drum 13 and the developing unit 20 are provided in an integral cartridge. When rotational shafts of the developing roller 21, the agitator 27, and the supply roller 29 are shaken during a rotation thereof, the quality of an image deteriorates so that a solution to reduce the vibration of the rotational shafts is needed. Also, since a plurality of gears for transfer of power to an outside of the cartridge of the developing unit 20 are installed, a solution to easily couple the plurality of gears and the rotational shafts is needed.

### SUMMARY OF THE INVENTION

The present general inventive concept provides a coupling structure usable with an image forming apparatus which can restrict (reduce) vibration of a rotary body forming usable with developing unit and simultaneously facilitate coupling of the rotary body and a plurality of gears thereof.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing a coupling structure usable with an image forming apparatus comprising a hopper frame to accommodate toner and to be installed with an agitator, a development frame coupled to the hopper frame and installed with a developing roller and a supply roller to supply the toner, a plurality of gears to rotate and drive each of the agitator, the developing roller, and the supply roller, a first coupling protrusion to protrude from an outer surface of the development frame, and a development cap member coupled to the outer surface of the development frame and having first and second bushings to rotatably support the developing roller and the supply roller and a coupling portion into which the first coupling protrusion is inserted.

The foregoing and/or other aspects of the present general inventive concept may also be achieved by providing coupling structure usable with an image forming apparatus, the coupling structure comprising a hopper frame to accommodate toner and an agitator installed therein, a development frame coupled to the hopper frame and installed with a developing roller and a supply roller to supply the toner to the developing roller, a first coupling protrusion formed on the development frame, a second coupling protrusion formed on the hopper frame, and a development cap member having a coupling portion to receive the first coupling protrusion of the development frame, a second coupling portion to receive the second coupling protrusion, and first and second bushings to receive rotational shafts of the supply roller and the developing roller.

The foregoing and/or other aspects of the present general inventive concept may also be achieved by providing an image forming apparatus comprising a photosensitive drum unit, and a coupling structure coupled to the photosensitive drum unit, and the coupling structure comprising a hopper frame to accommodate toner and an agitator installed therein, a development frame coupled to the hopper frame and installed with a developing roller and a supply roller to supply the toner to the developing roller, a plurality of gears to rotate and drive each of the agitator, the developing roller, and the supply roller, a first coupling protrusion to protrude from an outer surface of the development frame, and a development cap member coupled to the outer surface of the development frame and having first and second bushings to rotatably support the developing roller and the supply roller, and a coupling portion into which the first coupling protrusion is inserted.

The foregoing and/or other aspects of the present general inventive concept may also be achieved by providing an image forming apparatus comprising a photosensitive drum unit and a coupling structure to communicate with the photosensitive drum unit, the coupling structure comprising a hopper frame to accommodate toner and an agitator installed therein, a development frame coupled to the hopper frame and installed with a developing roller and a supply roller to supply the toner to the developing roller, a first coupling protrusion formed on the development frame, a second coupling protrusion formed on the hopper frame, and a development cap member having a coupling portion to receive the first coupling protrusion of the development frame, a second coupling portion to receive the second coupling protrusion, and first and second bushings to receive rotational shafts of the supply roller and the developing roller.

### BRIEF DESCRIPTION OF THE DRAWINGS

The above and other features and advantages of the present invention will become more apparent by describing in detail preferred embodiments thereof with reference to the attached drawings in which:

FIG. 1 is a cross-sectional view of a conventional image forming apparatus;

FIG. 2 is an exploded perspective view of a coupling structure of the image forming apparatus according to an embodiment of the present general inventive concept; and

FIG. 3 is a perspective view of the coupling structure of FIG. 2 in an assembled state.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

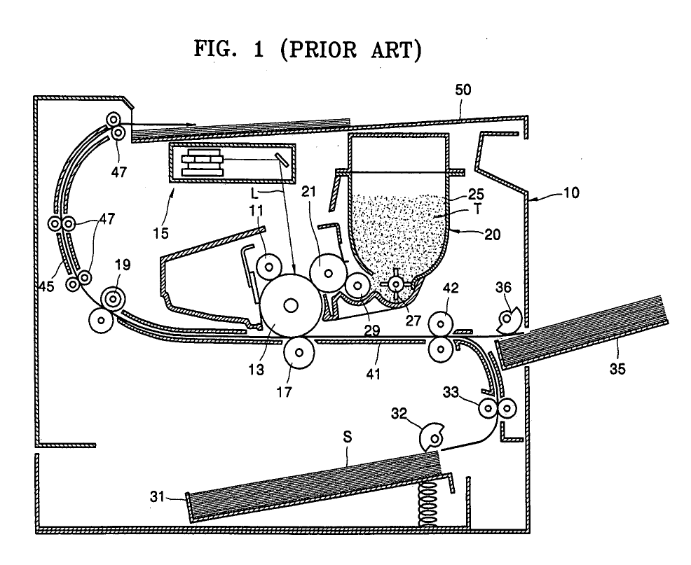

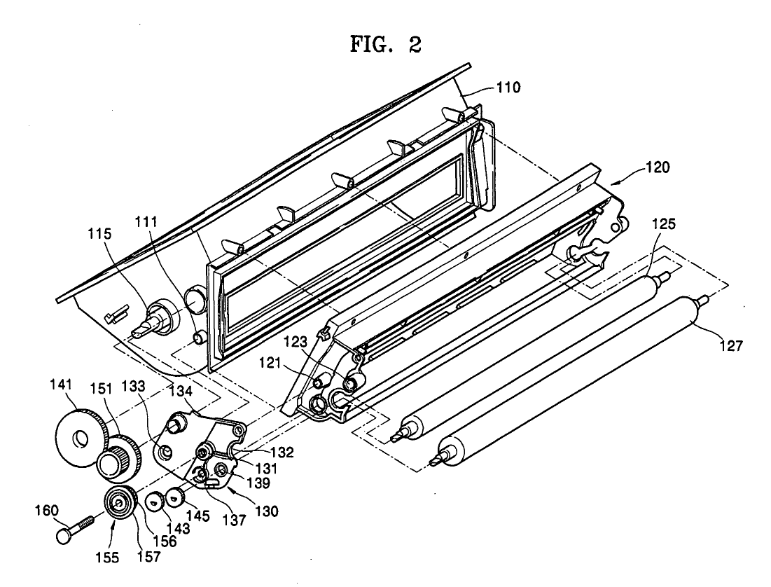

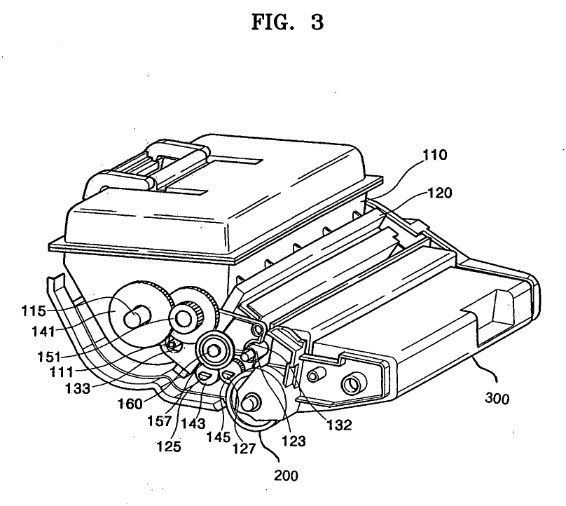

Referring to FIGS. 2 and 3, a coupling structure of an image forming apparatus according to an embodiment of the present general inventive concept restricts or reduces vibration of a plurality of rotary bodies during printing using development cap members 130 installed at both side surfaces of a hopper frame 110 and a development frame 120 and simultaneously performs a bushing function to rotatably support the rotary bodies. A conventional image forming apparatus of FIG. 1 may be used as the image forming apparatus having the coupling structure of FIGS. 2 and 3.

The hopper frame 110 accommodates toner therein and includes an agitator 115 which agitates the toner and transfers the toner toward the development frame 120. The development frame 120 is coupled to the hopper frame 110 and installed with a developing roller 127 and a supply roller 125 to supply the toner to the developing roller 127. A first coupling protrusion 121 protrudes from an outer surface of the development frame 120 to be coupled a corresponding one of development cap members 130.

Each development cap member 130 is coupled to the outer surface of the development frame 120 and formed in a single body. Here, another development frame (not shown in FIG. 2) is coupled to an opposite side surface of the development frame 120. The another development frame coupled to a rear side surface (or the opposite side surface) of the development frame 120 has the substantially same structure as that of the development frame 130 which is coupled to a front side surface of the development frame 120 opposite to the rear side surface with respect to the developing roller 127 or a main body of the development frame 120. Accordingly, the description of another development frame is omitted herein.

The development cap member 130 includes a coupling portion 131 into which the first coupling protrusion 121 is inserted, and first and second bushings 137 and 139 to rotatably support the supply roller 125 and the developing roller 127, respectively. Thus, both supply roller 125 and developing roller 127 are rotatably supported by the development cap member 130.

A second coupling protrusion 111 protrudes from an outer surface of the hopper frame 110. The development cap member 130 further includes a coupling hole (or a second coupling portion) 133 in which the second coupling protrusion 111 is inserted. Thus, since the second coupling protrusion 111 is fixedly inserted into the coupling hole 133, vibration of the hopper frame 110 occurring during printing can be reduced.

Also, the development cap member 130 further includes a support portion 132 to support a shaft coupling protrusion 123 that protrudes from the outer surface of the development frame 120. The support portion 132 is defined by a surface formed at one side of the development cap member 130 to correspond to and contact a side surface of the shaft coupling protrusion 123 to restrict a vibration of the shaft coupling protrusion 123. The development cap member 130 further includes a stopper 134 which protrudes from a plate of the development cap member 130 in a portion between the development frame 120 and the hopper frame 110 and restricts or prevents a crack from being generated in the coupling portion.

The coupling structure according to the present embodiment includes a plurality of gears to rotate each of the agitator 115, the supply roller 125, and the development roller 127. The gears include first through third drive gears 141, 143, and 145 respectively coupled to the rotational shafts of the agitator 115, the supply roller 125, and the developing roller 127, a first intermediate gear 151 rotatably coupled to a boss formed on the outer surface of the development cap member 130 and driven while being engaged with the first drive gear 141, and a second intermediate gear 155 rotatably coupled to the coupling portion 131 to transfer power from the first intermediate fear 151 to the second and third drive gears 143 and 145.

The second intermediate gear 155 includes a gear portion 156 and an escape prevention flange 157 formed at a side of the gear portion 156. Thus, the first intermediate gear 151 and the second and third drive gears 143 and 145 engaged with the gear portion 156 of the second intermediate gear 155, can be prevented from escaping from the rotational shaft thereof without an additional coupling unit since the gear portion 156 of the intermediate gear 151 and the second and third drive gears 143 and 145 are disposed between the escape prevention flange 157 of the second intermediate gear 155 and the front (or rear) side surface of the development frame 120.

Referring to FIG. 3, the image forming apparatus having the coupling structure may include a photosensitive drum 200 to receive toner from the developing roller 127, and a waste toner container 300 to receive a remaining portion of the toner from the photosensitive drum 200. In addition to the coupling structure, the photosensitive drum 200, and the waste toner container 300, the image forming apparatus may use components of the conventional image forming apparatus of FIG. 1 to install the coupling structure of FIGS. 2 and 3 therein.

In the coupling structure configured as described above, since the coupling portion 131 is screw-coupled to the first coupling protrusion 121 using a single screw 160 that penetrates the second intermediate gear 155, the second and third drive gears 143 and 145, the first intermediate gear 151, and the development cap member 130 can be simultaneously coupled together.

As described above, according to the coupling structure usable with an image forming apparatus as described above, since first and second bushings that rotatably supports the supply roller and the developing roller respectively, the coupling portion that supports the shaft coupling protrusion of the development frame, and the coupling hole that supports the hopper frame are formed on the development single cap member, the coupling structure is simplified, and the vibration of the hopper frame and the development frame generated during printing can be reduced.

Also, since the escape prevention flange is formed at the second intermediate gear, and the second intermediate gear and the development cap member are coupled using a single screw, the first intermediate gear and the second and third drive gears are coupled without an additional coupling structure. Therefore, manufacturing process, time, and cost can be reduced.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A coupling structure usable with an image forming apparatus, comprising:
a hopper frame to accommodate toner and an agitator installed therein;
a development frame coupled to the hopper frame and installed with a developing roller and a supply roller to supply the toner to the developing roller;
a plurality of gears to rotate and drive each of the agitator, the developing roller, and the supply roller;
a first coupling protrusion to protrude from an outer surface of the development frame; and
a development cap member coupled to the outer surface of the development frame and having first and second bushings to rotatably support the developing roller and the supply roller, and a coupling portion into which the first coupling protrusion is inserted.

2. The coupling structure as claimed in claim 1, further comprising:
a second coupling protrusion to protrude from an outer surface of the hopper frame; and
a coupling hole formed in the development cap member to receive the second coupling protrusion.

3. The coupling structure as claimed in claim 2, further comprising:
a shaft coupling protrusion to protrude from the outer surface of the development frame; and
a support portion defined by a surface formed at a side of the development cap member to correspond to and contact a side of the shaft coupling protrusion to restrict vibration of the shaft coupling protrusion.

4. The coupling structure as claimed in claim 2, wherein the development cap member comprises a stopper which protrudes from the development cap member in a portion between the development frame and the hopper frame, and a movement of the hopper frame is limited by the stopper and a coupling between the first coupling protrusion and the coupling portion.

5. The coupling structure as claimed in claim 1, further comprising:
a shaft coupling protrusion to protrude from the outer surface of the development frame; and
a support portion defined by a surface formed at a side of the development cap member to correspond to and contact a side of the shaft coupling protrusion to restrict vibration of the shaft coupling protrusion.

6. The coupling structure as claimed in claim 1, wherein the development cap member further comprises a stopper which protrudes from the development cap member in a portion between the development frame and the hopper frame and to prevent a crack from being generated in the coupling portion.

7. The coupling structure as claimed in claim 6, wherein a movement of the development frame is limited by the stopper and a coupling between the first coupling protrusion and the coupling portion.

8. The coupling structure as claimed in claim 1, wherein the development cap member further comprises a stopper to protrude from the development cap member to limit a movement of the development frame with a coupling between the first coupling protrusion and the coupling portion.

9. The coupling structure as claimed in claim 1, further comprising:
an intermediate gear rotatably coupled to the development frame through the development cap member to transmit a rotation power among the plurality of gears, and having an escape prevention flange to prevent the plurality of gears from escaping from corresponding ones of the agitator, the supply roller, and the developing roller.

10. The coupling structure as claimed in claim 1, wherein the gears comprise:
first through third drive gears respectively coupled to rotational shafts of the agitator, the supply roller, and the developing roller;
a first intermediate gear rotatably coupled to the outer surface of the development cap member and driven by being engaged with the first drive gear; and
a second intermediate gear rotatably coupled to the coupling portion to transfer power from the first intermediate fear to the second and third drive gears.

11. The coupling structure as claimed in claim 10, wherein the development cap member comprises a first hole and a second hole through which the first intermediate gear and the second intermediate gear are rotatably coupled to the hopper frame and the development frame, respectively.

12. The coupling structure as claimed in claim 10, wherein the second intermediate gear comprises an escape prevention flange to prevent the second and third drive gears and the first intermediate gear from being escaped from corresponding ones of the rotational shafts of the agitator, the supply roller, and the developing roller, and the second and third drive gears, the first intermediate gear, and the development cap member are simultaneously coupled by screw-coupling the second intermediate gear to the first coupling protrusion to penetrate the coupling portion.

13. The coupling structure as claimed in claim 1, wherein the first and second bushings and the coupling portion of the development cap member are formed in a single monolithic body.

14. A coupling structure usable with an image forming apparatus, comprising:
a hopper frame to accommodate toner and an agitator installed therein;
a development frame coupled to the hopper frame and installed with a developing roller and a supply roller to supply the toner to the developing roller;
a first coupling protrusion formed on the development frame;
a second coupling protrusion formed on the hopper frame; and
a development cap member having a coupling portion to receive the first coupling protrusion of the development frame, a second coupling portion to receive the second coupling protrusion, and first and second bushings to receive rotational shafts of the supply roller and the developing roller.

15. The coupling structure as claimed in claim 14, wherein the development frame comprises a shaft coupling protrusion to protrude from a surface thereof, and the development cap member comprises a support portion formed thereon to contact a side of the shaft coupling protrusion of the development frame.

16. The coupling structure as claimed in claim 15, wherein the first coupling protrusion, the second coupling protrusion, and the shaft coupling protrusion are disposed to be spaced-apart from each other.

17. The coupling structure as claimed in claim 15, wherein the coupling portion, the second coupling portion, the support portion, and first and second bushings of the development cap member are formed in a single monolithic body.

18. The coupling structure as claimed in claim 14, further comprising:
a first gear disposed on the development cap member to be coupled to the agitator;
a second gear disposed on the development cap member to be coupled to the supply roller;
a third gear disposed on the development cap member to be coupled the developing roller; and
an intermediate gear coupled to the development frame to hold the second and third gears to be connected to corresponding ones of the supply, developing, and agitator gears.

19. The coupling structure as claimed in claim 18, further comprising:
another intermediate gear coupled to the hopper frame to transmit a rotational power from the first gear to the intermediate gear,
wherein the intermediate gear transmits the rotational power to the second and third gears.

20. An image forming apparatus, comprising:
a photosensitive drum unit; and
a coupling structure coupled to the photosensitive drum unit, and comprising:
a hopper frame to accommodate toner and an agitator installed therein,
a development frame coupled to the hopper frame and installed with a developing roller and a supply roller to supply the toner to the developing roller,
a plurality of gears to rotate and drive each of the agitator, the developing roller, and the supply roller,
a first coupling protrusion to protrude from an outer surface of the development frame, and
a development cap member coupled to the outer surface of the development frame and having first and second bushings to rotatably support the developing roller and the supply roller, and a coupling portion into which the first coupling protrusion is inserted.
